(19) United States
(12) Patent Application Publication
(10) Pub. No.: US 2017/0125987 A1
(43) Pub. Date: May 4, 2017

(54) SEPARATING AND INSULATION REMOVAL DEVICE FOR A CABLE-PROCESSING MACHINE

(71) Applicant: Schleuniger Holding AG, Thun (CH)

(72) Inventors: Sebastian BRAUN, Dresden (DE); Benjamin SCHÄFFER, Bischoffen (DE)

(73) Assignee: Schleuniger Holding AG, Thun (CH)

(21) Appl. No.: 15/341,608

(22) Filed: Nov. 2, 2016

(30) Foreign Application Priority Data
Nov. 4, 2015 (EP) 15192979.1

(51) Int. Cl. H02G 1/12

(52) U.S. Cl. CPC H02G 1/1258

(57) ABSTRACT

A separating and/or insulation removal device for a cable-processing machine has at least two knife blocks that can be moved in opposite directions, each with at least one knife. A cable that is to be cut to length and/or is to have its insulation removed can be guided between the knives, which are actuated by at least one drive for at least one of the knife blocks, and a mechanism for purposes of guiding at least the driven knife block in the direction towards the cable. The drive acts at least indirectly on an element of the mechanism. Each driven knife block sits on a lever at a distance from its lever axis and executes a pivotal movement along a circular arc. For this purpose, the drive engages with the lever via a rotatable force transmission element at a distance from the lever axis and the knife block.

### CROSS REFERENCE TO RELATED APPLICATIONS

This application claims the priority of the European Application No. EP15192979, filed on Apr. 11, 2015, which is here incorporated in its entirety by reference.

### BACKGROUND

The invention concerns a separating and insulation removal device for a cable-processing machine in accordance with disclosed embodiments.

Typically cutting and insulation removal units of known art, as disclosed for example in DE102010004781A1, implement the cutting and insulation removal movement in terms of a linear movement, which is generated by means of an eccentric from the rotation of a servo-drive. Here a common drive is provided for two knife blocks that can move in opposite directions, with at least one insulation removal knife pair and one separating knife pair. A first eccentric is arranged on a crankshaft of the drive for purposes of raising and lowering the first knife block, and a second eccentric is also arranged on the crankshaft for purposes of the simultaneous lowering and raising of the second knife block. The knife carriages move along at least one linear guide rail.

DE3601850A1 discloses another variant of a separating and insulation removal device, whose knife blocks, which can be moved in opposite directions, are also linearly guided for a movement in opposite directions towards the cable, or away from the cable. This movement is imposed onto the knife blocks via a mechanism, which has a cam disk that can be rotated by means of a motor; the path of the cam disk is scanned by a cam follower. The said cam follower is moved linearly in accordance with the cam path, and applies this movement in parallel to its associated knife block.

In the device in accordance with U.S. Pat. No. 5,038,457A the rotational movement of a drive motor is translated via a belt and articulated lever arrangement into a linear movement of the knife blocks.

A further variant for the actuation of the knife blocks, once again, however, along a linear displacement path radial to the cable that is being processed, is disclosed in EP0715384A2. Here the rotational movement of the drive motor is translated into a rotation of a spindle located in parallel with the displacement path, which spindle carries adjustment nuts, which are coupled with the knife carriers. With the rotation of the spindle the nuts, which are secured against rotation, are guided along the spindle and thereby move the knife carriers towards the cable, and, with a reversed direction of rotation of the spindle, away from the cable once again.

In JPS5443578U a conductor separating and insulation removal unit is disclosed that has three pairs of knives, with a central separating knife pair, and on either side of the latter an insulation removal knife pair. The module with the knife pair holders is arranged such that it can be moved linearly along guide axes in the direction of the conductor transport. The desired conductor length of cut is effected via a transport arrangement for the cable, the separating and insulation removal unit is then closed, wherein the separating knife pair severs the conductor, and the two laterally spaced insulation removal knives cut into the insulation of the conductor. Here the knife pair holders are moved linearly towards one another, wherein the opening and closing of the knives takes place by means of levers that are mounted fixed to a frame such that they can pivot, and with bearing rollers engage laterally in longitudinal grooves of the knife pair holders. Bearing rollers are mounted at the opposite ends of the lever; these interact with cam plates, which rotated by means of a shaft. The operating sequence requires drive movements of a plurality of shafts that are precisely co-ordinated with one another, on which shafts the cam plates and cam rollers are mounted. The design is relatively complicated.

EP0509192A1 discloses a device for the separating and removal of insulation from electrical cables in a cable-processing machine, wherein each knife block sits on a lever, and these levers have a common lever axis. The levers are driven via a number of separate gears for each lever; however, the gears are intermeshed, and a single motor acts on only one of the gears.

### SUMMARY

It was therefore the object of the present invention to develop a separating and insulation removal device, such that it is structured in a simpler manner than previous designs, and thereby offers increased functional reliability, cost-effective construction, and better utilisation of the drive power.

For purposes of achieving this object the features of the disclosed embodiments are provided. Further features and advantageous developments are presented in the description, the figures, and in the claims.

A device in accordance with one or more embodiments of the invention may include at least two levers that are located opposite one another and can pivot in opposite directions about a common lever axis, with a drive that engages with the lever, via a rotatable force transmission element, at least indirectly at a distance from the lever axis, with at least one knife block, with at least one knife on each lever, positioned at a distance from the lever axis and the force transmission element, which knife blocks, by pivoting of the levers, can be moved in opposite directions, wherein a cable that is to be cut to length and/or is to have its insulation removed can be guided through between the knives.

In accordance with the invention such a device is characterised in that the rotatable force transmission element of the drive engages simultaneously with both levers that are located opposite one another and can be moved in opposite directions. By this means mechanisms for the distribution of the drive action onto both knife blocks, which dissipate force and are subject to backlash, can thereby be eliminated. In overall terms this design has the advantage that it no longer requires a conversion of the rotational movement of the drive into a linear movement, that the required freedom from backlash is easier to achieve, and that the cutting movement can be implemented with a lower moment of inertia. In this manner, the necessary drive power can be reduced, which in addition to a rotational movement that can be implemented fundamentally more cost-effectively also saves costs in terms of the drive motor. For a given initial separation the knives can be closed more rapidly, as a result of which the device, whilst maintaining the advantages cited, also offers shorter cycle times.

A compact design is enabled by an inventive form of embodiment in which the point of engagement of the force transmission element with the levers lies in a plane that lies between the lever axis and the knife blocks and is preferably essentially parallel to the lever axis and the line connecting the knife blocks in their open position.

The compact design of the inventive device is improved further, in particular in the region of the lever axis and the force transmission element, if at least one of the levers that are located opposite one another and can be moved in opposite directions, has a lever section, starting from the lever axis, that is curved in the direction towards the knife blocks, and the force transmission element engages with this lever section.

The optional inventive feature also contributes to the improvement of this advantage, in that the force transmission element engages with a lever at a point between the lever axis and the knife block, and the lever section is located opposite the said point with respect to the force transmission element.

If at the same time each lever is provided with a roller, against which the force transmission element bears for the introduction of force into the lever, a better utilisation of the drive force and also protection of the components is ensured by the reduction in friction.

The force transmission element is preferably embodied as a cam plate, or cam disk.

In accordance with a preferred form of embodiment of the invention the cam plate or cam disk thereby has peripheral sections with a high gradient and adjoining them peripheral sections with a lower gradient. In this manner a different speed of movement of the knife blocks can be achieved with a uniform drive actuation that can thus be easily controlled. Passage through the peripheral sections with a high gradient preferably occurs at the start of the actuation movement of the knife blocks towards one another, and passage through the peripheral sections with a lower gradient occurs shortly before and during the contact of the knives with the cable, in order to effect a rapid approach of the knives towards the cable, but to enable a subsequent movement that can be more finely metered in the critical region in which the cable, and in particular the insulation, is being cut.

Freedom from backlash and an automatic return into the initial position can thereby be achieved with the open knife blocks simply and without any need for drive power, by imposing a force onto at least one of the levers by means of a spring element in the direction towards a position in which the knife block is at a distance from the cable.

At least one of the levers is preferably provided with a sliding guide for the lever that is located opposite.

In accordance with the invention a significant simplification of the design and a reduction in the complexity of construction can be achieved if two levers that are located opposite one another and can be moved in opposite directions are each provided with a separating knife and an insulation removal knife. In this manner both the separating process and also the removal of insulation can be executed sequentially with a pair of levers with only one drive.

A programmable electric motor is provided as a preferred form of embodiment for the drive, preferably a servomotor, or a stepping motor.

Further advantages, features, and details of the invention ensue from the following description, in which examples of embodiment of the invention are described with reference to the figures. Here, each of the features referred to in the claims and in the description can be essential to the invention either individually or in any combination.

### BRIEF DESCRIPTION OF THE DRAWING

The list of reference symbols is an integral part of the disclosure, as is also the technical content of the patent claims and the figures. The figures are described coherently and comprehensively. The same reference symbols denote the same components; reference symbols with different indices specify components with the same or similar functions.

Here:

FIG. 1 shows in an exemplary manner a view of an example of embodiment of an inventive cutting and insulation removal unit in the direction of the cable axis,

FIG. 2 shows a view of the active elements of the device of FIG. 1, also seen in the direction of the cable axis,

FIG. 3 shows a view corresponding to that of FIG. 2, but without the substructure,

FIG. 4 shows a view corresponding to that of FIG. 3 with the knives completely closed, and

FIG. 5 shows a perspective view corresponding to that of FIG. 3, from a direction almost transverse to the cable axis.

### DETAILED DISCLOSURE

FIG. 1 shows the whole of the cutting and insulation removal unit including its casing 11, together with the waste containers 12 for purposes of accommodating pieces of insulation and conductors that have been severed.

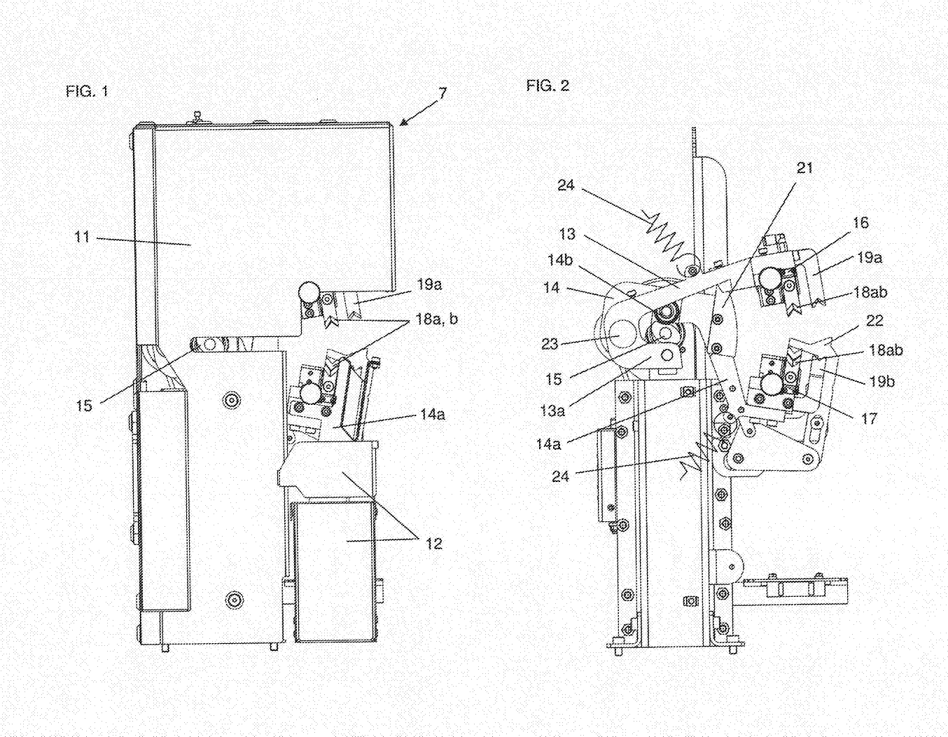

FIG. 2 represents—after removal of the casing 11—the inventive kinematics of the shearing process. In the inventive cutting and insulation removal unit 7 a new concept for the drive and kinematics is introduced in which the cutting and insulation removal process, instead of the linear movement that has been usual up to the present time, is an inventive part of a pivotal movement of the knife blocks 16, 17. The movement is reminiscent of a shearing cut, wherein the “cutting region” is only present at the outermost region of the upper shear half 13 and the lower shear half 14, in which are mounted the driven upper knife block 16 and the lower knife block 17, which in the example represented is also driven. Forms of embodiment with only one pivotable and/or driven lever 13 or 14 are also possible.

In a typical spatial arrangement with essentially horizontal cable guidance the cutting and insulation removal unit 7 has an upper lever 13 and a lower lever 14, which are mounted on a common pivotal axis 23. This pivotal axis 23 is preferably at least essentially parallel to the axis of the cable that is guided through the cutting and insulation removal unit 7. At the tips of the levers, at a distance from the pivotal axis 23, sit the knife blocks 16 and 17, each of which holds a central separating knife 18a, and on either side of the separating knife 18a the insulation removal knives 18b. In addition, reject part knives 19a (upper) and 19b (lower) are attached to each of the knife block mountings. In the separating and insulation removal process these elements execute a pivotal movement along a circular arc about the lever axis 23.

The separating knife 18a and the two insulation removal knife pairs 18b are arranged with different lengths, but are spaced apart from one another in pairs. This ensures that the centrally arranged separating knife 18a, which projects forward relative to the insulation removal knives 18b, can in a simple manner part a conductor arranged transversely with respect to the knife pair. The now cut to length conductor ends are then axially pulled back from the separating knife 18a, and are respectively positioned between the two insulation removal knife pairs 18b for removal of the insulation. The insulation removal knives 18b are moved by the same mechanism 13, 14, 15 as the separating knives 18a, until the desired depth of cut into the insulation is achieved. The conductor ends are then axially pulled back by means of conventional conductor transport devices of known art, and the insulation sleeves are stripped from the metallic conductors of the conductor ends by the insulation removal knives 18b and into the container 12. By this means a greater complexity, with separate drives for the separating knives 18a and insulation removal knives 18b, can be avoided, since the axis of the conductor to be processed is in any event the same and the processes must be executed one after another.

The closing movement of the levers 13, 14 of the cutting and insulation removal unit 7 is effected by means of a cam plate 15 as a force transmission element. The said plate 15, operatively connected with a drive 20, for example via a toothed belt, a geared transmission or similar, transforms the rotational movement of a servomotor 20 into the pivotal movement of the shear halves 13 and 14. The axis of the drive 20 and/or at least the axis of the cam plate 15 is preferably at least essentially parallel to the pivotal axis 23 of the levers 13, 14 and/or at least essentially parallel to the axis of the cable guided through the cutting and insulation removal unit 7.

The servomotor 20, or any equivalent programmable electric motor that can be employed, for example, a stepping motor, in all cases provides for the closing movement of the knives 18a, 18b, 19. The programmed angle of rotation of the cam plate 15 is precisely initiated by means of the servomotor 20, so that e.g. the insulation removal knives 18b can assume an exact separation distance from one another, which is necessary for correct removal of the insulation without damaging the internal conductor of the cable. The spring elements 24, which are held in tension, ensure permanent contact of the levers 13 and 14 with the cam plate 15, so that the insulation removal knives cannot close too far in an inadvertent or uncontrolled manner. Following on from the insulation removal process the direction of rotation of the servomotor 20 is reversed, and the shear halves 13 and 14 open once again, which opening movement is effected via the pre-tensioning of the spring elements 24. This also offers the advantage that no reversing backlash can occur between the opening and closing movements. A drive 20, and the force transmission element 15 connected with it, are preferably provided such that there is simultaneous engagement with both levers 13, 14 that are located opposite one another. The opening movement and also the closing movement of the levers 13, 14 can also be effected by a positive form of control with the interaction of a positive guidance system between the levers 13, 14 and the force transmission element 15, in that, for example, pins on the force transmission element 15 are guided in guide slots on the levers 13, 14. Furthermore forms of embodiment are possible in which the force transmission element 15 only operates on one of the levers 13 or 14, and the driving action onto the other lever takes place via a lever or gearing link from the driven lever, and not from the force transmission element 15.

A lever 13 of the shear halves 13, 14 extends essentially straight from the region of the lever 23, via the region of the interaction with the cam plate 15, and as far as the outermost end of the lever with the knife block 16. The said lever is preferably embodied such that starting from the lever axis 23, a lever section 13a is provided that is curved over, or curved back, in the direction towards the knife blocks 16, 17. The force transmission element 15 then preferably engages with the said lever section 13a. In contrast the lever 14, preferably also starting from an essentially straight section between the lever axis 23 and the region of the interaction with the cam plate 15, is curved or bent away from the opposite located lever 13, and at its end is curved back again into essentially the original direction, in order to create space for the accommodation of the lower knife carrier 17.

Other designs for the levers 13, 14 are conceivable as long as the positioning accuracy that can be achieved with regard to the insulation removal depth of cut/quality and the cutting force available to the separating knife 18a or the insulation removal knife 18b is ensured. Moreover, a sufficient opening dimension between the knife pairs 18a, 18b is required so that conductors can be guided through between the open knives.

The force transmission element 15 engages with a lever 14 at a point between the lever axis 23 and the knife block 17, wherein the lever section 13a, also pointing away from the lever axis 23, is located opposite this point with respect to the force transmission element 15.

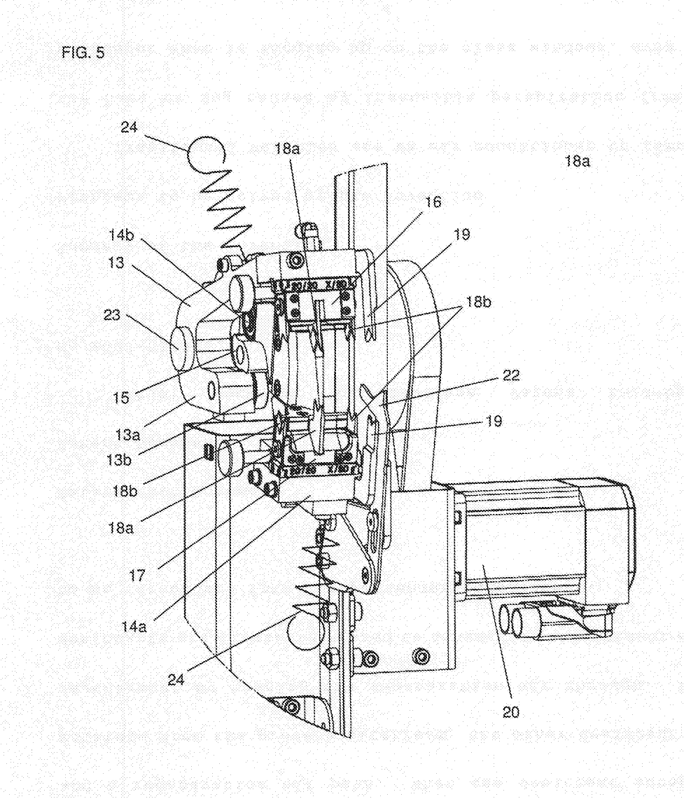

For purposes of guiding the shear halves 13 and 14 relative to one another a sliding guide 21 is installed between the levers 13 and 14. This prevents problems from being able to arise as a result of oscillations or displacements in the conductor direction between the levers 13 and 14. Preferably, but from the technical point of view not necessarily, a conductor lifter 22 is provided (see FIG. 5), which also executes a pivotal movement.

In order to prevent friction each lever 13, 14 is preferably provided with a roller 13a, 14a that can rotate parallel to the lever axis 23, that is to say, parallel to the axis of rotation of the cam plate 15 that is parallel to the latter. The cam plate 15, acted upon by the spring elements 24, bears against the said rollers 13a, 14a and applies the force required for the pivoting of the levers 13, 14 onto the levers 13, 14 via the said rollers 13a, 14a. Needless to say, other friction-reducing designs are possible, for example, inserts of friction-reducing material in the levers 13, 14.

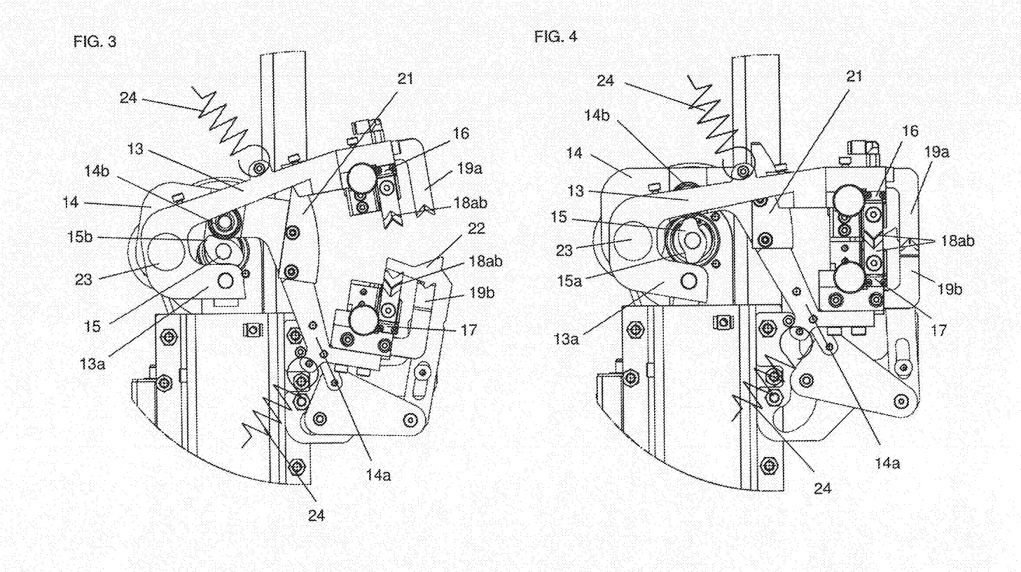

FIGS. 3 and 4 show the end positions of the sequence of the closing movement of the cutting and insulation removal unit 7. The levers 13 and 14 are driven by means of the rotation of the cam plate 15. After activation of the drive the latter features in the first peripheral section of the rotational movement a peripheral region 15a with a high gradient, which is followed by a peripheral section 15b with a low gradient. This enables a faster action in the region of large shear opening (FIG. 3), at the cost of accuracy, and a slower and more precise action in the region of small shear opening (FIG. 4)—in which accuracy is required.

In overall terms this design has the advantage that it no longer requires a conversion of the rotational movement of the drive 20 into a linear movement; the required lack of backlash in the drive path of the knife blocks 16, 17 is easier to achieve, and the cutting movement can be implemented with a lower moment of inertia. In this manner the necessary drive power can be reduced, which in addition to a rotational movement that can be implemented fundamentally more cost-effectively, further reduces costs for the drive motor 20.

### LIST OF REFERENCE SYMBOLS

7 Cutting and insulation removal unit
11 Casing
12 Waste container
13 Upper lever
13a Lever section
13b Roller
14 Lower lever
14a Curved lever section
14b Roller
15 Cam plate
15a Peripheral section with high gradient
15b Peripheral section with low gradient
16 Upper knife block
17 Lower knife block
18a Separating knife
18b Insulation removal knife
19a, b Upper and lower reject part knives
20 Servomotor
21 Sliding guide
22 Conductor lifter
23 Axis of rotation
24 Spring element

1. A separating and insulation removal device (7) for a cable-processing machine, comprising:
at least two levers (13, 14) that are located opposite one another and can pivot in opposite directions about a common lever axis (23),
a drive (20) that engages with the lever (13, 14) via a rotatable force transmission element (15), at least indirectly at a distance from the lever axis (23),
at least one knife block (16, 17), with at least one knife (18) on each lever (13, 14), positioned at a distance from the lever axis (23) and the force transmission element (15), which knife blocks (16, 17), by pivoting of the levers (13, 14), can be moved in opposite directions,
wherein a cable that is to be cut to length and/or is to have its insulation removed can be guided through between the knives (18), and
wherein the rotatable force transmission element (15) of the drive (20) engages simultaneously with both levers (13, 14) that are located opposite one another and can be moved in opposite directions.

2. The device in accordance with claim 1, wherein the point of engagement of the force transmission element (15) with the levers (13, 14) lies in a plane that lies between the lever axis (23) and the knife blocks (16, 17) and is essentially parallel to the lever axis (23) and a line connecting the knife blocks (16, 17) in their open position.

3. The device in accordance with claim 1, wherein at least one (13) of the levers (13, 14) that are located opposite one another and can be moved in opposite directions, has a lever section (13a), starting from the lever axis (23), that is curved in the direction towards the knife blocks (16, 17) and the force transmission element (15) engages with this lever section (13a).

4. The device in accordance with claim 1, wherein the force transmission element (15) engages with at least one of the two levers at a point between the lever axis (23) and the knife block (17), and the lever section (13a) is located opposite the said point with respect to the force transmission element (15).

5. The device in accordance with claim 1, wherein each lever (13, 14) is provided with a roller (13b, 14b), against which the force transmission element bears for the introduction of force into the levers (13, 14).

6. The device in accordance with claim 1, wherein the force transmission element (15) is embodied as a cam plate or cam disk.

7. The device in accordance with claim 6, wherein the cam plate or cam disk (15) thereby has peripheral sections with a high gradient, and adjoining them peripheral sections with a lower gradient, wherein passage through the peripheral sections with a high gradient preferably occurs at the start of the actuation movement of the knife blocks (16, 17) towards one another, and passage through the peripheral sections with a lower gradient occurs shortly before and during the contact of the knives (18) with the cable.

8. The device in accordance with claim 1, wherein a force is imposed upon at least one of the levers (13, 14) by means of a spring element (24) in the direction towards a position with the knife block (16, 17) at a distance from the cable.

9. The device in accordance with claim 1, wherein at least one of the levers (13, 14) is provided with a sliding guide (21) for the lever that is located opposite.

10. The device in accordance with claim 1, wherein two levers (13, 14) that are located opposite one another and can be moved in opposite directions are each provided with a separation knife (18a) and an insulation removal knife (18b).

11. The device in accordance with claim 1, wherein the drive (20) is a programmable electric motor, preferably a servomotor or a stepping motor.
